(19) United States
(12) Patent Application Publication
(10) Pub. No.: US 2025/0149274 A1
(43) Pub. Date: May 8, 2025

(54) AIR CIRCUIT BREAKER

(71) Applicant: LS ELECTRIC CO., LTD., Anyang-si, Gyeonggi-do (KR)

(72) Inventor: Hanbaek CHUNG, Anyang-si, Gyeonggi-do (KR)

(21) Appl. No.: 18/835,126

(22) PCT Filed: Jan. 12, 2023
(86) PCT No.: PCT/KR2023/000582

§ 371 Date: Aug. 1, 2024

(30) Foreign Application Priority Data
Mar. 3, 2022 (KR) 10-2022-0027199

(51) Int. Cl. H01H 33/08

(52) U.S. Cl. CPC H01H 33/08

(57) ABSTRACT

An air circuit breaker is disclosed. The air circuit breaker, according to an aspect of the present disclosure, may comprise: an operation unit in which an arc is generated by operating a mover with respect to a stator; an arc extinguishing unit installed on an upper portion of the operation unit and primarily extinguishing the arc; and an insulation member installed on one side of the arc extinguishing unit and blocking a moving space of high temperature gas between the arc extinguishing unit and a terminal to prevent the high temperature gas generated in the arc extinguishing unit from moving toward the terminal. According to this configuration, the insulation member may insulate an arc moving from the arc extinguishing unit to the terminal.

### CROSS-REFERENCE TO RELATED APPLICATIONS

This application is the National Stage filing under 35 U.S.C. 371 of International Application No. PCT/KR2023/000582, filed on Jan. 12, 2023, which claims the benefit of earlier filing date and right of priority to Korean Application No. 10-2022-0027199, filed on Mar. 3, 2022, the contents of which are all hereby incorporated by reference herein in their entirety.

### FIELD

The present disclosure relates to an air circuit breaker, and more particularly, to an air circuit breaker capable of suppressing a short-circuit of a terminal.

### BACKGROUND

In general, a circuit breaker according to the related art protects a power system and a load device by opening and closing a device that receives power from a transmission or substation system or power line or blocking a current when safety accidents such as overload, short-circuit, etc. occur.

The related art circuit breaker includes a mover and a stator that is contactable with the mover. When the mover is in contact with the stator, a current flows along a line. When a large current flows on the line due to a safety accident, the mover is separated from the stator, and the current on the line is cut off.

Recently, as the electric capacity of a power system has increased, a circuit breaker is required to carry a large current.

The related art air circuit breaker splits an arc that is generated when interrupting an overcurrent/short-circuit accident through grids within an arc chamber and extinguishes the arc in the air. However, as for a DC air circuit breaker, a blocking process is more severe than that in an AC circuit breaker. The AC air circuit breaker has a characteristic in which a current zero is caused once every half a cycle. In general, a circuit breaker according to the related art protects a power system and a load device by opening and closing a device that receives power from a transmission or substation system or power line or blocking a current when safety accidents such as overload, short-circuit, etc. occur.

The related art circuit breaker includes a mover and a stator that is contactable with the mover. When the mover is in contact with the stator, a current flows along a line. When a large current flows on the line due to a safety accident, the mover is separated from the stator, and the current on the line is cut off.

Recently, as the electric capacity of a power system has increased, a circuit breaker is required to carry a large current.

The related art air circuit breaker splits the arc generated when interrupting an overcurrent/short-circuit accident through grids within an arc chamber and extinguishes the arc in the air.

However, as for a DC air circuit breaker, a blocking process is more severe than that in an AC circuit breaker.

For example, the AC air circuit breaker has a characteristic in which a current zero is caused once every half a cycle. On the other hand, since there is no current zero caused in the DC air circuit breaker, the arc must be split into smaller arcs to make an arc voltage higher. Accordingly, more metal grids are disposed, which narrows a gap between the grids.

An arc that is generated when an air circuit breaker interrupts a fault is split into plasma in an arc extinguishing unit, and finally extinguished while discharging metal gas. At this time, as explained earlier, the DC air circuit breaker has a narrow gap between the grids, which makes the metal gas discharged faster and farther. When the discharged metal gas was brought into contact with a bus bar terminal, the bus bar terminal was shorted, which brought about secondary short-circuit accidents.

### SUMMARY

The present disclosure is intended to solve the above problems, and an aspect of the present disclosure is to provide an air circuit breaker that is capable of suppressing high-temperature metal gas, which has primarily been extinguished in an arc extinguishing unit, from flowing toward a nearby terminal.

The problems to be solved in the present disclosure may not be limited to the aforementioned, and other problems to be solved by the present disclosure, which are not mentioned, will be obviously understood by a person skilled in the art based on the following description.

In order to achieve the above-described aspects, according to one aspect of the present disclosure, there is provided an air circuit breaker including: an operation unit in which an arc is generated by an operation of a mover with respect to a stator; an arc extinguishing unit that is installed on an upper portion of the operation unit and primarily extinguishes the arc; and an insulation member that is installed on one side of the arc extinguishing unit and blocks a movement space of high-temperature gas between the arc extinguishing unit and a terminal.

At this time, the insulation member may be an insulating paper manufactured by compressing paper.

At this time, the arc extinguishing unit may include a frame and an upper cover panel that covers an upper surface of the frame, and one end of the insulation member may be fixed between the frame and the upper cover panel.

At this time, another end, a free end, of the insulation member may be bent toward the upper cover panel where metal gas is exhausted.

At this time, the insulation member may include a through hole formed therethrough such that a fastening member for fastening the frame and the upper cover panel passes.

At this time, the insulation member may have elasticity to maintain a shape thereof even when the arc extinguishing unit is drawn out and pushed in.

At this time, the insulation member may be made of a flexible material.

An air circuit breaker according to the present disclosure includes: a body portion that has a plurality of terminals exposed to outside; side panels that are coupled to left and right surfaces of the body portion; a main body that is drawn forward out of or pushed backward into the body portion and the side panels; an operation unit that is disposed inside the main body, and includes a stationary portion and a moving portion generating an arc when being in contact with or separated from the stationary portion; an arc extinguishing unit that is disposed on an upper portion of the operation unit and primarily extinguishes the arc; and an insulation member that is installed on the rear of the arc extinguishing unit to suppress the arc from moving toward the plurality of terminals.

At this time, an arc cover may be mounted above the arc extinguishing unit and exhaust the arc, and the insulation member may be accommodated inside the arc cover.

At this time, sliding panels may be disposed on left and right surfaces of the main body, respectively, the sliding panels may be drawn forward or pushed backward with respect to the side panels together with the main body, and the operation unit and the extinguishing unit may be provided in plurality, respectively, and disposed alongside between the sliding panels.

At this time, a terminal portion may be disposed on a rear surface of the main body, the body portion may be disposed to overlap the terminal portion in a front-to-back direction, and the plurality of terminals may be formed to protrude from the body portion in a direction opposite to the terminal portion.

According to one embodiment, the arc extinguishing unit may include: a plurality of support plates that form left and right surfaces of the arc extinguishing unit; a frame that is supported on upper portions of the plurality of support plates; an upper cover panel that has a plurality of through holes and is mounted to cover an upper portion of the frame; and a plurality of grids that extend vertically between the plurality of support plates and have both left and right sides supportedly coupled to the support plates, to extinguish the arc, and one end portion of the insulation member may be disposed to be fastened to a rear end portion of the upper cover panel and a rear end portion of the frame.

According to another embodiment, the arc extinguishing unit may include: a frame that extends in a front-to-back direction; and an upper cover panel that has a plurality of through holes and covers an upper portion of the frame, and the insulation member may include: a fixed portion that is fixedly disposed between the frame and the upper cover panel; and a blocking portion that extends from the fixed portion to be upwardly inclined toward the front of the upper cover panel.

According to still another embodiment, the arc extinguishing unit may include: a frame that extends in a front-to-back direction; and an upper cover panel that has a plurality of through holes and covers an upper portion of the frame, and the insulation member may include: a fixed portion that is fixedly disposed between the frame and the upper cover panel; a bent portion that is formed to be bent upward from the fixed portion; and a blocking portion that extends from the bent portion to be upward inclined toward the front of the upper cover panel.

According to still another embodiment, wherein the insulation member may include a blocking portion that is formed to be inclined toward the front where the arc is discharged.

According to an embodiment of the present disclosure, the following effects can be achieved.

An air circuit breaker according to the present disclosure can suppress high-temperature metal gas from moving toward a terminal by virtue of an insulating paper, thereby suppressing secondary accidents.

The effects of the present disclosure are not limited to those described above, and should be understood to include all effects that can be inferred from the configuration of the disclosure described in the detailed description or claims of the present disclosure.

### BRIEF DESCRIPTION OF THE DRAWINGS

FIG. 1 is a rear perspective view of an air circuit breaker according to one embodiment of the present disclosure.

FIG. 2 is a rear perspective view illustrating a state in which an arc cover has been removed from the air circuit breaker according to one embodiment of the present disclosure.

FIG. 3 is a perspective view illustrating a state in which a body portion of the air circuit breaker according to one embodiment of the present disclosure has been detached.

FIG. 4 is a perspective view illustrating a state in which the body portion and an arc cover of the air circuit breaker according to one embodiment of the present disclosure have been detached.

FIG. 5 is a partially exploded perspective view illustrating a main body pulled out of the air circuit breaker according to one embodiment of the present disclosure.

FIGS. 6 and 7 are perspective views illustrating an arc extinguishing unit, as a component of the air circuit breaker according to one embodiment of the present disclosure, viewed from different angles.

FIG. 8 is a partially exploded perspective view illustrating the arc extinguishing unit, as the component of the air circuit breaker according to one embodiment of the present disclosure.

FIG. 9 is a partial cross-sectional view illustrating a side surface of the air circuit breaker according to one embodiment of the present disclosure.

### DETAILED DESCRIPTION

Hereinafter, embodiments of the present disclosure will be described in detail with reference to the accompanying drawings, so as to be easily implemented by those skilled in the art. The present disclosure may be implemented in many different forms and is not limited to the embodiment described herein. In order to clearly explain the present disclosure, parts not related to the description have been omitted in the drawings, and the same or equivalent components are given the same reference numerals throughout the specification.

The words and terms used in this specification and claims are not to be construed as limited in their usual or dictionary meanings, but should be interpreted with meaning and concepts consistent with the technical idea of the present disclosure according to the principle that the inventor can define terms and concepts in order to explain his or her disclosure in the best way.

Therefore, the embodiment described in the disclosure and the configuration illustrated in the drawings correspond to one preferred embodiment of the present disclosure, and do not represent all of the technical ideas of the disclosure, so the corresponding configuration may be replaced with various equivalents and modified examples at the time that the present disclosure is filed. Hereinafter, the embodiment of the present disclosure will be described in detail, with reference to the accompanying drawings, so that those skilled in the art can easily practice the embodiment. The present disclosure may be implemented in many different forms and is not limited to the embodiment described herein. In order to clearly explain the present disclosure, parts not related to the description have been omitted in the drawings, and the same or equivalent components are given the same reference numerals throughout the disclosure.

The words and terms used in the disclosure and claims are not to be construed as limited in their usual or dictionary meanings, but should be interpreted with meaning and concepts consistent with the technical idea of the present disclosure according to the principle that the inventor can define terms and concepts in order to explain his or her disclosure in the best way.

Therefore, the embodiment described in the disclosure and the configuration illustrated in the drawings correspond to a preferred embodiment of the disclosure, and do not represent all of the technical ideas of the disclosure, so the corresponding configuration may be replaced with various equivalents and modified examples at the time that the present disclosure is filed.

Terms such as “include” or “has” are used herein and should be understood that they are intended to indicate an existence of several components, functions or steps, disclosed in the specification, and it is also understood that greater or fewer components, functions, or steps may likewise be utilized.

It will be understood that when an element is referred to as being disposed at “front,” “rear,” “top,” or “bottom” of another element, it includes, unless otherwise specifically stated, not only a case where the element is disposed directly on “front,” “rear,” “top,” or “bottom” of another element, but also a case where an intervening element is present between the elements. In addition, when an element is “connected” to another element, it includes, unless otherwise stated, not only being directly connected to each other, but also indirectly connected to each other.

Hereinafter, an air circuit breaker according to one embodiment of the present disclosure will be described with reference to the drawings.

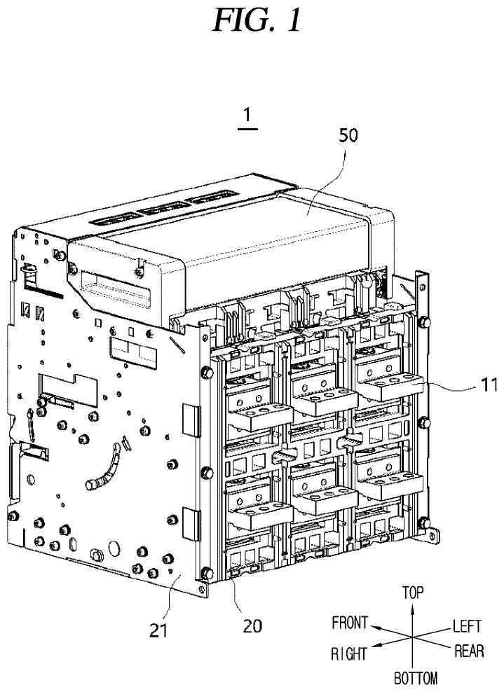

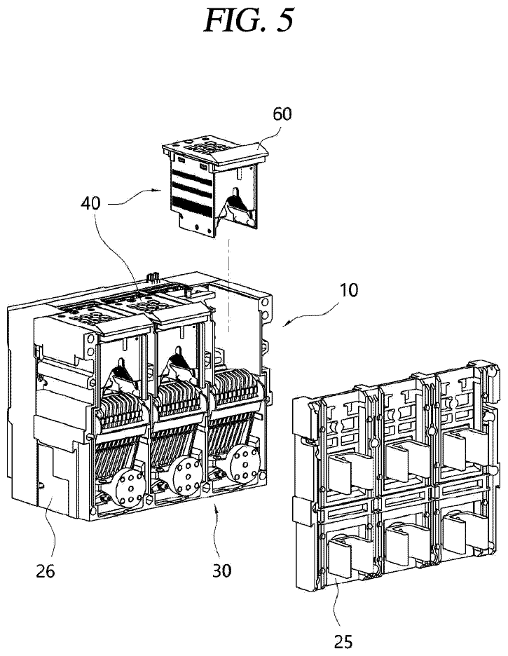

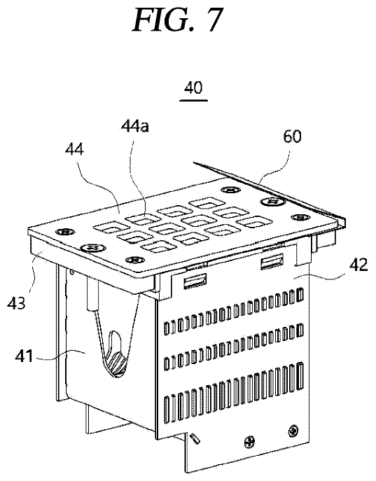

Referring to FIGS. 1 to 9, an air circuit breaker 1 according to one embodiment of the present disclosure may include an operation unit 30 (see FIG. 5), an arc extinguishing unit 40, and an insulation member.

The operation unit 30 is a part where an arc is generated when a mover operates with respect to a stator. Since the configuration of the operation unit 30 is the same as the related art one, a detailed description thereof will be omitted here.

At this time, air circuit breakers 1 may be classified into so-called fixed type and draw-out type. The fixed type is a type in which internal components are fixedly installed and difficult to be replaced, whereas the draw-out type is a type in which various components are drawn (pulled) out to be replaced depending on the conditions of internal components. In the case of having a structure, such as the draw-out type, in which internal components are drawn out and pushed in, a secondary accident may occur in which gas is partially discharged into a portion where metal gas should not be discharged. Therefore, it is very effective to apply the present disclosure in the case of the draw-out type. Of course, the present disclosure may be applicable even in the case of the fixed type.

Referring to FIGS. 5 to 9, the arc extinguishing unit 40 may be installed on an upper portion of the operation unit 30 and may primarily extinguish an arc.

At this time, a plurality of support plates 42 are installed on left and right surfaces of the arc extinguishing unit 40, respectively, and an arc guide is installed below the arc extinguishing unit 40. The arc extinguishing unit 40 includes an upper cover panel 44 disposed on a top thereof, and a plurality of grids 41 installed vertically therein at certain intervals. An arc generated in the operation unit 30 is extinguished while passing between the grids 41 of the arc extinguishing unit 40, and passes through through holes 44a of the upper cover panel 44 to enter a chamber of an arc cover 50. At this time, the arc is primarily extinguished in the extinguishing unit 40 and a high-temperature metal gas moves upward into the chamber of the arc cover 50.

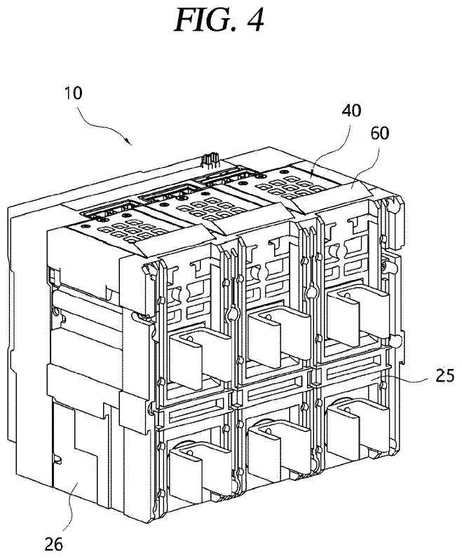

Referring to FIGS. 4 to 9, the insulation member is disposed on one side of the arc extinguishing unit 40. The insulation member may block a movement space of high-temperature gas, which is generated in the arc extinguishing unit 40, between the arc-extinguishing unit 40 and a terminal 11 to suppress the high-temperature gas from moving toward the terminal 11.

At this time, the insulation member may be an insulating paper 60 manufactured by compressing paper. The insulation member is made of an insulating material, and various materials may be applied as long as they have a thin panel shape like paper. In other words, for example, various synthetic resin materials such as rubber or epoxy may also be applied.

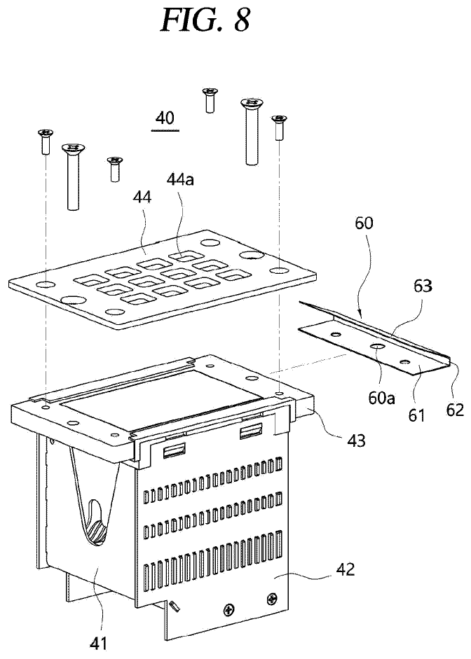

At this time, the arc extinguishing unit 40 may include a frame 43 and an upper cover panel 44 covering an upper surface of the frame 43, and one end of the insulating paper 60 may be fixed between the frame 43 and the upper cover panel 44. Referring to FIG. 8, a structure in which the insulating paper 60 is fixed between the frame 43 and the upper cover panel 44 of the arc extinguishing unit 40 by fastening members is illustrated.

At this time, the other end, as a free end, of the insulating paper 60 may be bent toward the upper cover panel 44 through which the metal gas is exhausted. The free end of the insulating paper 60 is bent toward the upper cover panel 44, and a portion to which the insulating paper 60 is fixed is a rear side of the arc extinguishing unit 40. In the case of a draw-out type air circuit breaker, there is a gap at the rear (i.e., rear gap) and the terminal 11 is disposed on the rear side of the air circuit breaker, high-temperature metal gas may be exhausted through the gap. Accordingly, the terminal 11 may be exposed to the high-temperature metal gas, which may cause a secondary accident. At this time, in the present disclosure, the insulating paper 60 can suppress the metal gas from moving toward the gap, thereby suppressing the secondary accident as well. At this time, in the case of a fixed type, there is no need to draw out internal components, so a gasket or the like to close a gap may be applied, but in the case of the draw-out type, it may be difficult to solve the problem by using the gasket because of a sliding movement of internal components. Therefore, the insulating paper 60 can be disposed on the front of the gap, thereby suppressing metal gas from directly passing through the gap.

At this time, the insulating paper 60 may include a through hole 60a formed therethrough, such that a fastening member for fastening the frame 43 and the upper cover panel 44 passes. Referring to FIG. 8, the through hole 60a is formed through a fixed portion 61 of the insulating paper 60, and the fastening member merely passes through the through hole 60a. That is, when the upper cover panel 44 and the frame 43 are fixedly fastened in close contact with each other by the fastening member, the fixed portion 61 of the insulating paper 60 may be fixed in a pressed manner between the upper cover panel 44 and the frame 43. Of course, since the fastening member is inserted through the through hole 60a, the insulating paper 60 is not separated.

At this time, the insulating paper 60 may have elasticity so as to maintain its shape even when the arc extinguishing unit 40 is drawn out and pushed in. Additionally, the insulating paper 60 may be made of a flexible material. The insulating paper 60 may be made of a flexible material while having elasticity, and may have a bent shape in its original state. In the case of the draw-out type, a physical interference may occur between the insulating paper 60 and components adjacent to the insulating paper 60 when the main body 10 is pushed in and drawn out. Therefore, the insulating paper 60 can have such a bent shape and be immediately restored to its original shape after the main body 10 is drawn out and pushed in.

Referring to FIG. 1, a rear perspective view of the air circuit breaker 1 according to one embodiment of the present disclosure is illustrated. The air circuit breaker 1 is a draw-out type and is generally produced in the form of a rectangular cabinet. The air circuit breaker 1 has a structure that allows some of internal components to be drawn out at the front. Terminals 11 are disposed on a body portion 20 to be exposed to the rear of the air circuit breaker 1, and side panels 21 are installed on side surfaces of the air circuit breaker 1 to guide a sliding movement. An arc cover 50 is installed on a top of the air circuit breaker 1 to accommodate metal gas exhausted from the arc extinguishing unit 40 for a certain period of time.

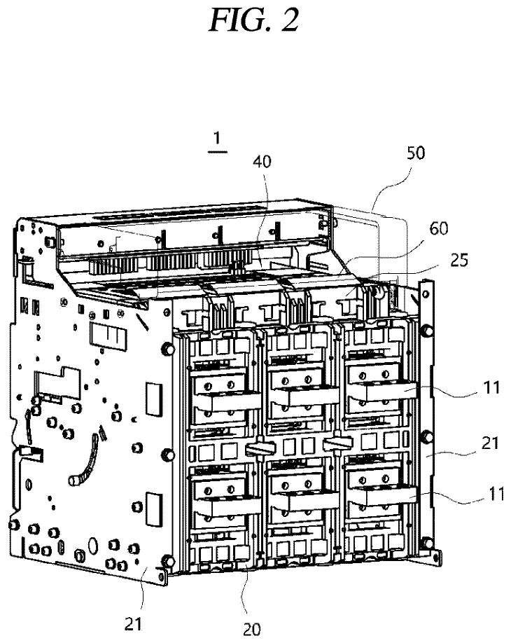

Referring to FIG. 2, a rear perspective view of a state where the arc cover 50 has been removed from the air circuit breaker 1 according to one embodiment of the present disclosure is illustrated. The arc-extinguishing unit 40 is installed below the arc cover 50, and the insulating paper 60 is installed on the rear of the arc-extinguishing unit 40. Therefore, even if high-temperature metal gas that is primarily extinguished in the extinguishing unit 40 moves upward, the insulating paper 60 can suppress the metal gas from flowing toward the rear terminal 11. At this time, the arc extinguishing unit 40 is provided in plurality, and of course, the insulating paper 60 is installed on each arc extinguishing unit 40.

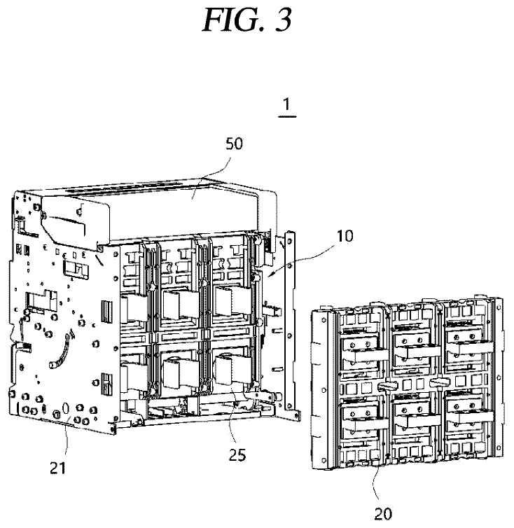

Referring to FIGS. 3 to 5, FIG. 3 is a perspective view illustrating a state in which the body portion of the air circuit breaker according to one embodiment of the present disclosure is detached, FIG. 4 is a perspective view illustrating a state in which the body portion 20 and the arc cover 50 of the air circuit breaker 1 have been detached, and FIG. 5 is a partially exploded perspective view illustrating the main body 10 drawn out of the air circuit breaker 1. In the air circuit breaker 1, the body portion 20 and the side panels 21 are fixed, and sliding panels 26 disposed on side surfaces of the main body 10 may be pulled forward together with the main body 10. The main body 10 includes a terminal portion 25, and the operation unit 30 and the arc extinguishing unit 40 are installed inside the terminal portion 25 sequentially from the bottom. Therefore, an arc generated in the operation unit 30 moves upward and enters the extinguishing unit 40. The arc is primarily extinguished in the arc extinguishing unit 40, and an extinguished high-temperature metal gas moves from the extinguishing unit 40 to the arc cover 50. At this time, the arc cover 50 is formed in the shape like a box, and an exhaust port is formed through a side surface of the arc cover 50. Therefore, the arc cover 50 accommodates the high-temperature metal gas for a certain period of time and then guides it to the exhaust port to be exhausted. At this time, some of the high-temperature metal gas may flow into a gap in the rear of the arc extinguishing unit 40, but this can be suppressed by the insulating paper 60. Therefore, a secondary accident due to a short-circuit of the terminal can be suppressed.

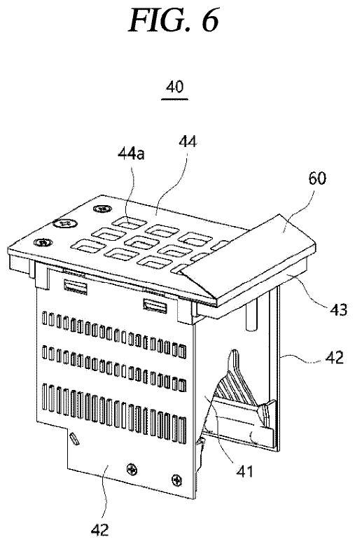

Referring to FIGS. 6 to 8, FIGS. 6 and 7 are perspective views illustrating the arc extinguishing unit 40, as the component of the air circuit breaker according to one embodiment of the present disclosure, viewed from different angles, and FIG. 8 is a partially exploded perspective view illustrating the arc extinguishing unit 40, as the component of the air circuit breaker 1. Upper ends of the support plates 42 are fixedly fastened to both sides of the frame 43 of the arc extinguishing unit 40, and the grids 41 are fixed vertically between the support plates 42 to be spaced apart at intervals. The upper cover panel 44 is fixedly fastened to an upper surface of the frame 43 by fastening members. At this time, the fixed portion 61 of the insulating paper 60 is fixedly disposed between the upper surface of the frame 43 and the lower surface of the upper cover panel 44. The insulating paper 60 is installed on the rear of the arc extinguishing unit 40 to suppress metal gas from permeating into the rear gap.

At this time, the insulating paper 60 may include a fixed portion 61, a bent portion 62, and a blocking portion 63. The fixed portion includes a plurality of through holes 60a, through which fastening members can be inserted. The bent portion 62 is a portion that allows the blocking portion 63 to be tilted in a forward direction where the metal gas is discharged. The blocking portion 63 is a portion tilted forward and guides the metal gas not to flow rearward. As described above, the insulating paper 60 has the bent shape and is made of the elastic material. Therefore, even if the insulating paper 60 interferes with other components when the main body 10 is drawn out and pushed in, the insulating paper 60 returns to its original bent state after the main body 10 is drawn out and pushed in.

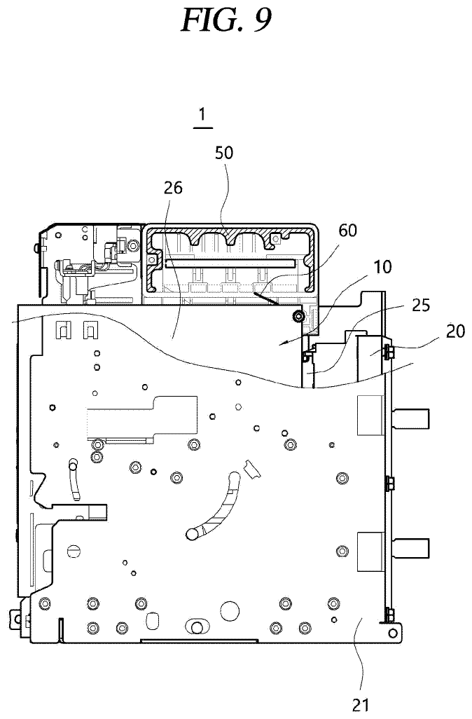

Referring to FIG. 9, a partial cross-sectional view of the side surface of the air circuit breaker 1 according to one embodiment of the present disclosure is illustrated. The metal gas moving upward in the arc extinguishing unit 40 flows into the chamber of the arc cover 50. At this time, a part of the metal gas rising at the rear is suppressed from moving rearward by the guidance of the insulating paper 60. At this time, a gasket may be installed between the insulating paper 60 and the body portion 20 to be in close contact with each other, thereby completely blocking the metal gas from being exhausted rearward. In addition, even if there is no gasket, the high-temperature metal gas is guided by the insulating paper 60 to primarily stay inside the arc cover 50 for a certain period of time. Accordingly, even if the metal gas whose temperature has dropped is exhausted through the rear gap, an occurrence of a secondary accident can be suppressed.

Although the embodiment of the present disclosure has been described, the idea of the present disclosure is not limited to the embodiment presented in this specification, and those skilled in the art who understand the scope of the present disclosure can easily propose other embodiments by addition, change, deletion, etc. of components within the scope of the same technical idea, but it should be understood that those addition, change, deletion, etc. are embraced within the technical idea of the present disclosure.

1. An air circuit breaker comprising:
an operation unit in which an arc is generated by an operation of a mover with respect to a stator;
an arc extinguishing unit that is installed on an upper portion of the operation unit and primarily extinguishes the arc; and
an insulation member that is installed on one side of the arc extinguishing unit and blocks a movement space of high-temperature gas between the arc extinguishing unit and a terminal.

2. The air circuit breaker of claim 1, wherein the insulation member is an insulating paper manufactured by compressing paper.

3. The air circuit breaker of claim 1, wherein the arc extinguishing unit comprises a frame and an upper cover panel that covers an upper surface of the frame, and one end of the insulation member is fixed between the frame and the upper cover panel.

4. The air circuit breaker of claim 3, wherein another end, a free end, of the insulation member is bent toward the upper cover panel where metal gas is exhausted.

5. The air circuit breaker of claim 3, wherein the insulation member comprises a through hole formed therethrough such that a fastening member for fastening the frame and the upper cover panel passes.

6. The air circuit breaker of claim 1, wherein the insulation member has elasticity to maintain a shape thereof even when the arc extinguishing unit is drawn out and pushed in.

7. The air circuit breaker of claim 1, wherein the insulation member is made of a flexible material.

8. An air circuit breaker comprising:
a body portion that has a plurality of terminals exposed to outside;
side panels that are coupled to left and right surfaces of the body portion;
a main body that is drawn forward out of or pushed backward into the body portion and the side panels;
an operation unit that is disposed inside the main body, and comprises a stationary portion and a moving portion generating an arc when being in contact with or separated from the stationary portion;
an arc extinguishing unit that is disposed on an upper portion of the operation unit and primarily extinguishes the arc; and
an insulation member that is installed on the rear of the arc extinguishing unit to suppress the arc from moving toward the plurality of terminals.

9. The air circuit breaker of claim 8, wherein an arc cover is mounted above the arc extinguishing unit and exhausts the arc, and
the insulation member is accommodated inside the arc cover.

10. The air circuit breaker of claim 8, wherein sliding panels are disposed on left and right surfaces of the main body, respectively, and
the sliding panels are drawn forward or pushed backward with respect to the side panels together with the main body, and
the operation unit and the extinguishing unit are provided in plurality, respectively, and disposed alongside between the sliding panels.

11. The air circuit breaker of claim 8, wherein a terminal portion is disposed on a rear surface of the main body,
the body portion is disposed to overlap the terminal portion in a front-to-back direction, and
the plurality of terminals are formed to protrude from the body portion in a direction opposite to the terminal portion.

12. The air circuit breaker of claim 8, wherein the arc extinguishing unit comprises:
a plurality of support plates that form left and right surfaces of the arc extinguishing unit;
a frame that is supported on upper portions of the plurality of support plates;
an upper cover panel that has a plurality of through holes and is mounted to cover an upper portion of the frame; and
a plurality of grids that extend vertically between the plurality of support plates and have both left and right sides supportedly coupled to the support plates, to extinguish the arc, and
one end portion of the insulation member is disposed to be fastened to a rear end portion of the upper cover panel and a rear end portion of the frame.

13. The air circuit breaker of claim 8, wherein the arc extinguishing unit comprises:
a frame that extends in a front-to-back direction; and
an upper cover panel that has a plurality of through holes and covers an upper portion of the frame,
the insulation member comprises:
a fixed portion that is fixedly disposed between the frame and the upper cover panel; and
a blocking portion that extends from the fixed portion to be upwardly inclined toward the front of the upper cover panel.

14. The air circuit breaker of claim 8, wherein the arc extinguishing unit comprises:
a frame that extends in a front-to-back direction; and
an upper cover panel that has a plurality of through holes and covers an upper portion of the frame,
the insulation member comprises:
a fixed portion that is fixedly disposed between the frame and the upper cover panel;
a bent portion that is formed to be bent upward from the fixed portion; and
a blocking portion that extends from the bent portion to be upwardly inclined toward the front of the upper cover panel.

15. The air circuit breaker of claim 8, wherein the insulation member comprises a blocking portion that is formed to be inclined toward the front where the arc is discharged.
